(19) United States
(12) Patent Application Publication
(10) Pub. No.: US 2004/0141458 A1
(43) Pub. Date: Jul. 22, 2004

(54) Apparatus and method for reducing peak to average power ratio in an orthogonal frequency division multiplexing system

(75) Inventors: Sung-Eun Park, Suwon-si (KR); Jae-Yoel Kim, Gunpo-si (KR); Dae-Kwon Jung, Suwon-si (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/754,803

(22) Filed: Jan. 9, 2004

(30) Foreign Application Priority Data
Jan. 14, 2003 (KR) P2003-2450

(51) Int. Cl. H04J 11/00

(52) U.S. Cl. 370/208; 370/210

(57) ABSTRACT

An apparatus and method for PAPR reduction in an OFDM system are disclosed. On a transmission side, an information sequence is generated by adding CRC bits to an information bit stream and masked with a plurality of different mask sequences. The masked information sequences are inverse-fast-Fourier-transformed. An IFFT sequence having the lowest PAPR is selected among the IFFT sequences.

### PRIORITY

This application claims priority under 35 U.S.C. § 119 to an application entitled “Apparatus and Method for Reducing Peak to Average Power Ratio in an Orthogonal Frequency Division Multiplexing System” filed in the Korean Intellectual Property Office on Jan. 14, 2003 and assigned Serial No. 2003-2450, the contents of which are incorporated herein by reference.

### BACKGROUND OF THE INVENTION

1. Field of the Invention

The present invention relates generally to PAPR (Peak to Average Power Ratio) reduction in an OFDM (Orthogonal Frequency Division Multiplexing) system, and in particular, to an apparatus and method for transmitting a masked information sequence having a low PAPR without transmitting additional information about a mask sequence.

2. Description of the Related Art

A signal transmitted on a radio channel is subject to multi-path interference due to a variety of obstacles between a transmitter and a receiver. The characteristic of a multi-path radio channel can be described by a maximum delay spread and a signal transmission period. If the signal transmission period is longer than the maximum delay spread, no interference occurs between successive signals and the channel features frequency non-selective fading in a frequency domain. On the other hand, in the case of wideband high-rate transmission, the signal transmission period is shorter than the maximum delay spread, and as a result, interference occurs between successive signals and a received signal undergoes inter-symbol interference.

The channel features frequency selective fading in the frequency domain, and a single-carrier transmission scheme using coherent modulation requires an equalizer to eliminate the inter-symbol interference. Also, as the data rate increases, distortion caused by the inter-symbol interference increases dramatically, and as such an increase in equalizer complexity is required. As a solution to the equalizer problem in the single-carrier transmission scheme, an OFDM system has been proposed. The OFDM system transmits data in parallel by a plurality of orthogonal sub-carriers and approximates a frequency-selective fading channel to a frequency non-selective channel from the perspective of each sub-channel. Therefore, the frequency-selective fading channel can be easily compensated for by use of a simple single-tap equalizer.

The OFDM system inserts guard intervals to avoid inter-channel interference caused by multi-path channel delay between adjacent symbols. The length of a guard interval must be greater than the maximum delay spread of the radio channel. The OFDM system maintains orthogonality between the sub-carriers with the aid of FFT (Fast Fourier Transform) and IFFT (Inverse Fast Fourier Transform), thereby achieving an increase in the data transmission efficiency. The OFDM system is viable only if orthogonality is maintained between sub-carriers. Otherwise, the OFDM system experiences inter-channel interference. The orthogonality between sub-carriers is not preserved in three cases. The first case is where a receiver is not synchronized, which adversely affects the performance of the OFDM system. The second case is where the channel fades time-selectively within an OFDM symbol period, and the resulting lack of orthogonality causes inter-channel interference.

The third case is where an increase in the number of sub-carriers leads to a Gaussian probability distribution of the amplitudes of modulated signals according to a central limit theorem, and, as a result, a transmission signal has a high PAPR. Therefore, more severe non-linear distortions than in a single-carrier transmission scheme are produced because of the non-linear saturation of a high-power amplifier used to secure enough transmission power for a radio channel.

Many methods have been proposed and are being studied to overcome the shortcomings of the OFDM system. Selective mapping (SLM) is one effort being used to reduce the PAPR. The SLM generates N mutually independent information bit streams representing the same input information bits and selects an information bit stream having the lowest PAPR.

As one of the SLM schemes, the N independent information bit streams are generated using predetermined mask sequences. The N information bit streams are produced by multiplying the input information bits by the mask sequences of length L.

Despite its ability to maintain a data rate, the above mask sequence-based SLM requires a rapid increase in the number of calculations to calculate the PAPR as the number of the information bit streams increases. Moreover, a transmitter/receiver needs a memory for storing the mask sequences, and the receiver must be informed of a mask sequence selected by the transmitter, which requires additional system resources.

FIGS. 1 and 2 are block diagrams of a transmitter and a receiver for reducing PAPR based on the mask sequence-based SLM.

Referring to FIG. 1, in the transmitter adopting the mask sequence-based SLM, a channel encoder 100 encodes information b its received as a binary signal. A symbol mapper 110 maps the code symbols on a signal constellation. A modulation such as QPSK, 8PSK, 16QAM or 64QAM is available to the symbol mapper 110. The number of bits per symbol depends on a modulation scheme used. One symbol has 2 bits in QPSK, 3 bits in 8PSK, 4 bits in 16QAM, and 6 bits in 64QAM.

The output of the symbol mapper 110 forms one signal block with N signals corresponding to N input points of each of IFFTs 140 to 146. The signal block from the symbol mapper 110 is copied to U signal blocks and the U signals blocks are provided into U branches to multipliers 130 to 136.

A mask generator 120 generates U independent mask sequences M₁, M₂, . . . , M_{U}, each mask sequence having length N. The mask generator 120 feeds the U independent mask sequences M₁, M₂, . . . , M_{U}, to the multipliers 130 to 136. The multipliers 130 to 136 multiply the signal block from the signal mapper 110 by the mask sequences.

The IFFTs 140 to 146 inverse-fast-Fourier transform the outputs of the multipliers 130 to 136. A selector 150 calculates the PAPR of each signal block received from the IFFTs 140 to 146, selects a signal block having the lowest PAPR, and transmits the selected signal block. Information about a mask sequence Mᵢ resulting in the selected signal block by multiplication is also transmitted as additional information via a different channel.

FIG. 2 is a block diagram of the receiver being the counterpart of the transmitter illustrated in FIG. 1. An FFT 200 fast-Fourier-transforms symbols received from the transmitter, while a controller 210 receives the additional information about the mask sequence corresponding to the selected modulation symbols as transmitted via a channel other than the channel delivering the modulation symbols by the transmitter.

The controller 210 generates the mask sequence Mᵢ selected by the transmitter using the additional information. A multiplier 220 multiplies the modulation symbols by the mask sequence Mᵢ, thereby recovering the original signal before being masked. That is, the multiplier 220 functions to eliminate the mask generated by the mask generator 120 illustrated in FIG. 1 from the modulation symbols.

A symbol demapper 230, having the same signal constellation as that of the symbol mapper 110, converts the symbols received from the multiplier 220 to a binary signal. That is, the symbol demapping depends on the symbol mapping. For example, if the modulation is QPSK, the demodulation is carried out based on QPSK. If the modulation is 8PSK, the demodulation is carried out based on 8PSK. A channel decoder 240 decodes the binary signal by a decoding method in correspondence with the coding method of the channel encoder 100. By the above process, the receiver can receive the information bits transmitted from the transmitter.

The above mask sequence-based SLM reduces PAPR by selectively transmitting a signal block having the lowest PAPR among U signal blocks resulting from the same information bits. As the number of signal blocks having the same information increases, the effect of PAPR reduction is significantly improved. As described with reference to FIGS. 1 and 2, however, due to transmission via a separate channel of additional information about the mask sequence for the selected signal block on, the mask sequence-based SLM requires an additional transmitter/receiver or an additional channel for the transmission and reception of the additional information, resulting in increased system complexity and cost. Moreover, if the receiver fails accurately to recover the additional information, the receiver cannot recover the transmission signal. Hence, a lower error probability than the transmission signal must be ensured for the additional information. To do so, an additional channel encoding is needed.

### SUMMARY OF THE INVENTION

An object of the present invention is to substantially solve at least the above problems and/or disadvantages and to provide at least the advantages below. Accordingly, an object of the present invention is to provide an apparatus and method for reducing PAPR without the need for transmitting to a receiver via an additional channel information about a mask sequence used in a transmitter.

Another object of the present invention is to provide a PAPR reducing apparatus and method which need not transmit additional information about a mask sequence via an additional channel, thereby preventing the increase of system complexity without and preventing errors which may be generated when the additional information is not accurately recovered.

The above objects are achieved by an apparatus and method for PAPR reduction in an OFDM system.

According to one aspect of the present invention, in an OFDM system where the same information bit stream is masked with a plurality of different mask sequences and a masked information bit sequence having the lowest PAPR is selected for transmission among a plurality of masked information bit sequences, provided is a method of generating the selected masked information bit sequence for transmission to a receiver without having to transmit the mask sequence information via a separate channel, wherein an information sequence is generated by adding CRC bits to an information bit stream. A plurality of masked information sequences are generated by masking the information sequence with a plurality of different mask sequences. IFFT sequences are generated by inverse-fast-Fourier-transforming the masked information sequences. An IFFT sequence having the lowest PAPR is selected among the IFFT sequences.

According to another aspect of the present invention, in an OFDM system where the same information bit stream is masked with a plurality of different mask sequences and a masked information bit sequence having the lowest PAPR is selected for transmission among a plurality of masked information bit sequences, provided is an apparatus for generating the selected masked information bit sequence for transmission to a receiver without having to transmit the mask sequence information via a separate channel, wherein a CRC generator generates an information sequence by adding CRC bits to an information bit stream. A plurality of maskers generates a plurality of masked information sequences by masking the information sequence with a plurality of different mask sequences. An IFFT generates IFFT sequences by inverse-fast-Fourier-transforming the masked information sequences. A selector selects an IFFT sequence having the lowest PAPR among the IFFT sequences.

According to a further aspect of the present invention, in an OFDM system where the same information bit stream is masked with a plurality of different mask sequences and a masked information bit sequence having the lowest PAPR is selected for transmission among a plurality of masked information bit sequences, provided is a method of determining the selected masked information bit sequence received from a transmitter without having to receive the mask sequence information via a separate channel, wherein an FFT sequence is generated by fast-Fourier-transforming a received masked information sequence. The FFT sequence is masked with a plurality of different mask sequences used by a transmitter. An error check is performed using CRC bits of each of the masked information sequences. A mask sequence is selected by the transmitter according to the CRC check results.

According to still another aspect of the present invention, in an OFDM system where the same information bit stream is masked with a plurality of different mask sequences and a masked information bit sequence having the lowest PAPR is selected for transmission among a plurality of masked information bit sequences, provided a method of determining the selected masked information bit sequence received from a transmitter without having to receive the mask sequence information via a separate channel, wherein an FFT sequence is generated by fast-Fourier-transforming a received masked information sequence and symbol-demapped. The demapped information sequence is decoded. The decoded information sequence is masked with a predetermined mask sequence and an error check is performed using CRC bits of the masked information sequence. A mask sequence selected by a transmitter is detected according to the CRC check result and information bits are generated by masking the decoded information sequence with the detected mask sequence.

According to further still another aspect of the present invention, in an OFDM system where the same information bit stream is masked with a plurality of different mask sequences and a masked information bit sequence having the lowest PAPR is selected for transmission among a plurality of masked information bit sequences, provided is an apparatus for determining the selected masked information bit sequence received from a transmitter without having to receive the mask sequence information via a separate channel, wherein a FFT generates an FFT sequence by fast-Fourier-transforming a received masked information sequence. A masker masks the FFT sequence with a plurality of different mask sequences used by a transmitter. A CRC checker checks errors by CRC bits of each of the masked information sequences. A selector detects a mask sequence selected by the transmitter according to the CRC check results and selects a masked information sequence corresponding to the detected mask sequence.

According to yet another aspect of the present invention, in an OFDM system where the same information bit stream is masked with a plurality of different mask sequences and a masked information bit sequence having the lowest PAPR is selected for transmission among a plurality of masked information bit sequences, provided is an apparatus for determining the selected masked information bit sequence received from a transmitter without having to receive the mask sequence information via a separate channel, wherein an FFT generates an FFT sequence by fast-Fourier-transforming a received masked information sequence. A symbol demapper demaps the FFT sequence. A channel decoder decodes the demapped information sequence. A masker masks the decoded information sequence with a predetermined mask sequence. A CRC checker for checking errors by CRC bits of the masked information sequence. A controller detects a mask sequence selected by a transmitter according to the CRC check result and generates information bits by masking the decoded information sequence with the detected mask sequence.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a transmitter for reducing PAPR based on a conventional SLM in an OFDM system;

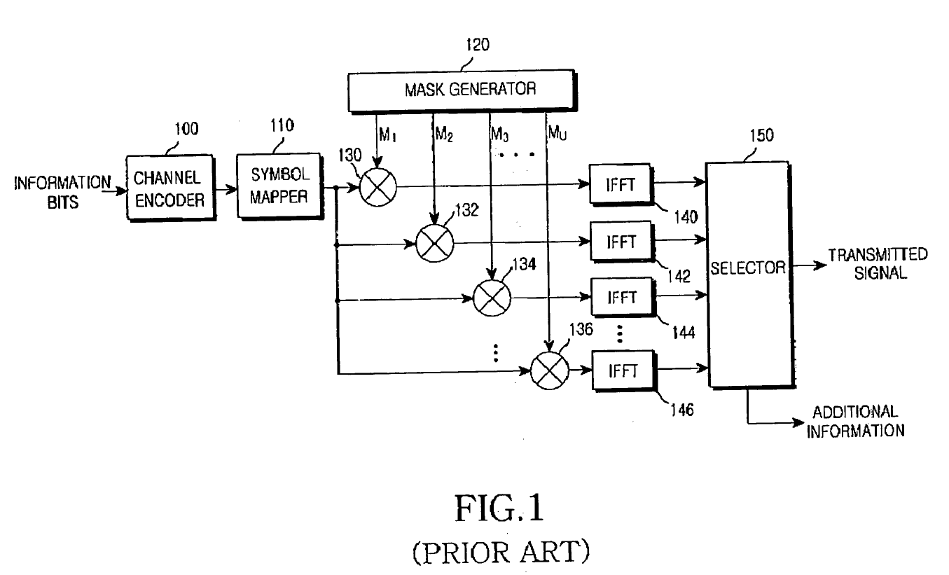

FIG. 2 is a block diagram of a receiver being the counterpart of the transmitter illustrated in FIG. 1;

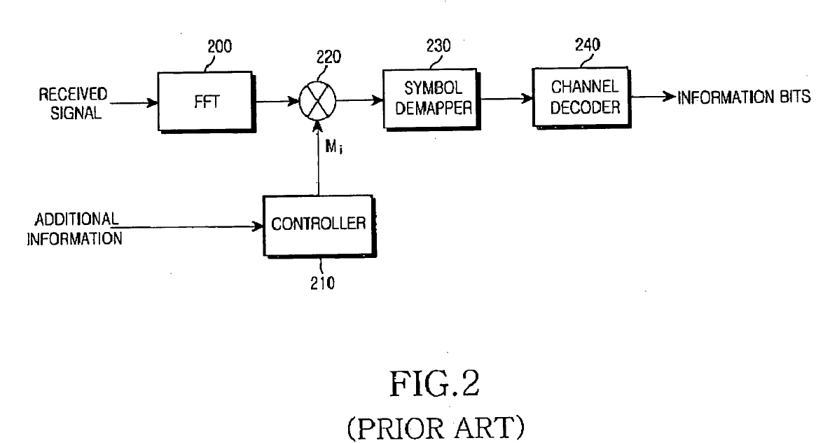

FIG. 3 is a block diagram of a CRC (Cyclic Redundancy Code) generator applied to transmitters according to the present invention;

FIG. 4 is a block diagram of a transmitter for reducing PAPR in an OFDM system according to an embodiment of the present invention;

FIG. 5 is a block diagram of a receiver for reducing PAPR in the OFDM system according to the embodiment of the present invention;

FIG. 6 is a block diagram of a transmitter for reducing PAPR in an OFDM system according to a second embodiment of the present invention;

FIG. 7 is a block diagram of a receiver for reducing PAPR in the OFDM system according to the second embodiment of the present invention; and

FIG. 8 is a block diagram of a receiver for reducing PAPR in an OFDM system according to a third embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail. It is to be appreciated herein that an EX-OR gate and an adder are used in the same sense and operate on input data on a bit-by-bit basis.

In the present invention, a transmitter-selected mask sequence is detected using a CRC in a mask sequence-based SLM. Therefore, the SLM is effectively implemented in an OFDM system without transmitting additional information about the selected mask sequence.

A CRC is cyclic block code used on a transmission side, for error correction. An input signal is shifted at shift registers and the shifted signals are fed back to EX-OR gates in a CRC generator.

Before describing the present invention, a CRC generator applied to the present invention will first be described.

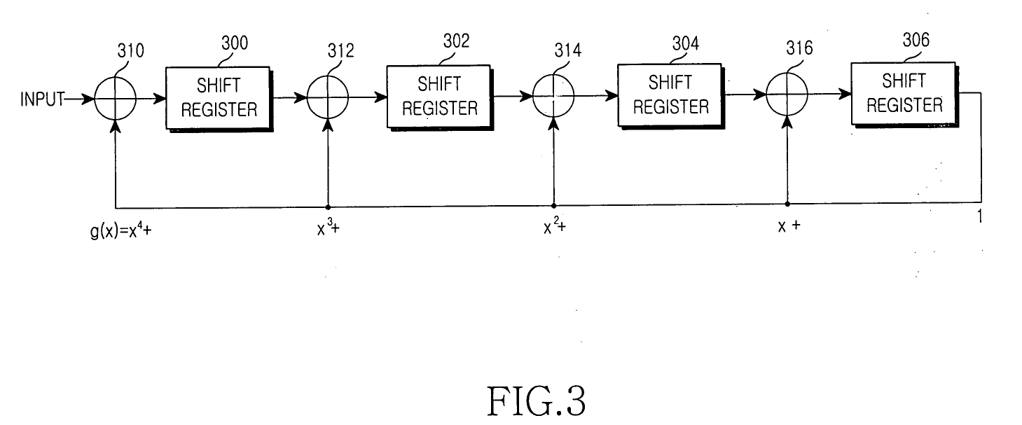

FIG. 3 is a block diagram of a CRC generator applied to embodiments of the present invention.

The CRC generator usually comprises a plurality of shift registers and a plurality of EX-OR gates. Referring to FIG. 3, the CRC generator includes four shift registers 300 to 306 and four EX-OR gates 310 to 316. Obviously, the CRC generator can be configured in different ways according to a general CRC generator implementation method.

If 12 information bits, 101000110110 are input to the CRC generator, 4 zeroes are added to the information bits because a CRC generator polynomial is a fourth-order polynomial in the CRC generator.

The CRC generator polynomial in defined as g(x)=x⁴+x³+x²+x+1. Since it is a fourth-order polynomial, 4 zeroes are appended to the information bits. Hence,

CRC generator input bits=1010001101100000

The CRC generator input bits are sequentially applied to the CRC generator, starting from the leftmost bit. It is assumed that a bit is moved from a shift register to the following shift register at time t1 and a bit is moved from the following shift register to the second following shift register at time t2. The shift registers 300 to 306 are all set to 0s, initially.

At t1, the EX-OR gate 310 exclusive-OR operates the first input bit 1 and the initial value 0 at the shift register 306 and the shift register 300 has the resulting value 1. The EX-OR gate 312 exclusive-OR operates the initial value 0s at the shift registers 300 and 306 and the shift register 302 has the resulting value 0. The EX-OR gate 314 exclusive-OR operates the initial value 0s at the shift registers 302 and 306 and the shift register 304 has the resulting value 0. The EX-OR gate 316 exclusive-OR operates the initial value 0s at the shift registers 304 and 306 and the shift register 306 has the resulting value 0. Therefore, 1, 0, 0, 0 are stored in the shift registers 300 to 306 at t1.

At t2, the EX-OR gate 310 exclusive-OR operates the second input bit 0 and the value 0 stored at the shift register 306 at t1 and the shift register 300 has the resulting value 0. The EX-OR gate 312 exclusive-OR operates the value 1 stored at the shift register 300 at t1 with the value 0 stored at the shift register 306 at t1 and the shift register 302 has the resulting value 0. The EX-OR gate 314 exclusive-OR operates the value 0 stored at the shift register 302 at t1 with the value 0 stored at the shift register 306 at t1 and the shift register 304 has the resulting value 0. The EX-OR gate 316 exclusive-OR operates the value 0 stored at the shift register 304 at t1 with the value 0 stored at the shift register 306 at t1 and the shift register 306 has the resulting value 0. Therefore, 0, 1, 0, 0 are stored in the shift registers 300 to 306 at t2.

At t3, the EX-OR gate 310 exclusive-OR operates the third input bit 1 and the value 0 stored at the shift register 306 at t2 and the shift register 300 has the resulting value 1. The EX-OR gate 312 exclusive-OR operates the value 0 stored at the shift register 300 at t2 with the value 0 stored at the shift register 306 at t2 and the shift register 302 has the resulting value 0. The EX-OR gate 314 exclusive-OR operates the value 1 stored at the shift register 302 at t2 with the value 0 stored at the shift register 306 at t2 and the shift register 304 has the resulting value 1. The EX-OR gate 316 exclusive-OR operates the value 0 stored at the shift register 304 at t2 with the value 0 stored at the shift register 306 at t2 and the shift register 306 has the resulting value 0. Therefore, 1, 0, 1, 0 are stored in the shift registers 300 to 306 at t3. Table 1 below lists values stored at the shift registers for the input of the CRC generator input bits.

TABLE 1

| | CRC input | Register | | | |
|---|---|---|---|---|---|
| time | bits | 300 | Register 302 | Register 304 | Register 306 |
| t1 | 1 | 1 | 0 | 0 | 0 |
| t2 | 0 | 0 | 1 | 0 | 0 |
| t3 | 1 | 1 | 0 | 1 | 0 |
| t4 | 0 | 0 | 1 | 0 | 1 |
| t5 | 0 | 1 | 1 | 0 | 1 |
| t6 | 0 | 1 | 0 | 0 | 1 |
| t7 | 1 | 0 | 0 | 1 | 1 |
| t8 | 1 | 0 | 1 | 1 | 0 |
| t9 | 0 | 0 | 0 | 1 | 1 |
| t10 | 1 | 0 | 1 | 1 | 0 |
| t11 | 1 | 1 | 0 | 1 | 1 |
| t12 | 0 | 1 | 0 | 1 | 0 |
| t13 | 0 | 0 | 1 | 0 | 1 |
| t14 | 0 | 1 | 1 | 0 | 1 |
| t15 | 0 | 1 | 0 | 0 | 1 |
| t16 | 0 | 1 | 0 | 1 | 1 |
| t17 | | 1 | 0 | 1 | 0 |
| t18 | | 0 | 1 | 0 | 1 |
| t19 | | 1 | 1 | 0 | 1 |

As noted from Table 1, the CRC generator has 1, 1, 0, 1 at the respective shift registers 300 to 306 after the final exclusive-OR operation.

Embodiment 1

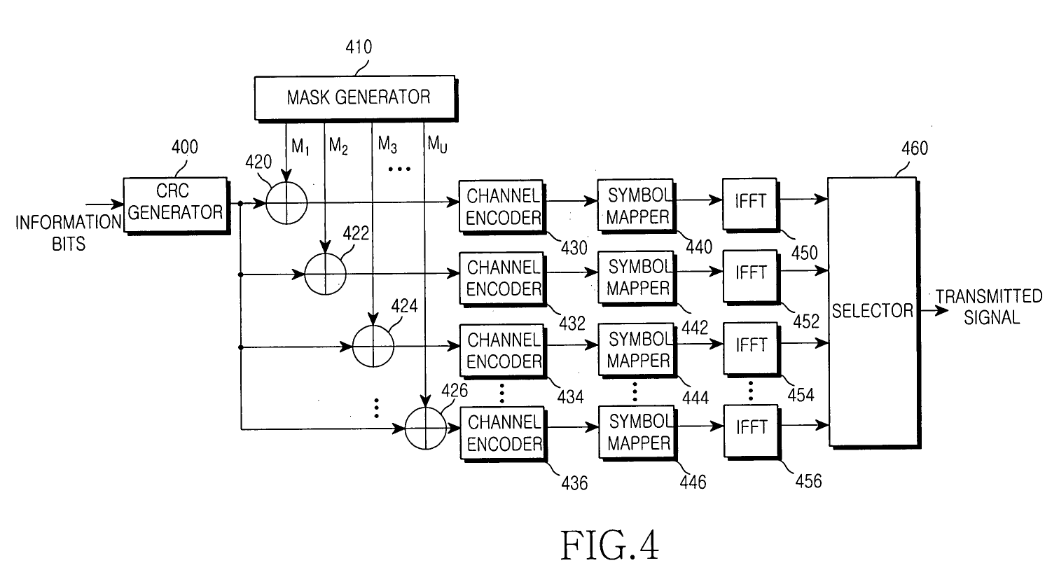

FIG. 4 is a block diagram of an OFDM transmitter based on the mask sequence-based SLM according to an embodiment of the present invention.

Referring to FIG. 4, information bits, for example, 101000110110, are applied as a binary signal to the input of a CRC generator 400. The CRC generator 400 appends the CRC bits, 1101 generated in the manner as described with reference to FIG. 3 to the information bits. Therefore,

Information bits+CRC bits=1010001101101101

The information bits attached with the CRC bits are copied to a plurality of same information bit streams and applied to a plurality of (e.g. U) adders 420 to 426. Meanwhile, a mask generator 410 generates a plurality of mask sequences. If the mask generator 410 generates 4 mask sequences (i.e. U=4), they are defined as

M₁=1 0 0 1 0 0 1 1 0 1 1 1 0 0 0 1

M₂=0 1 0 1 1 0 0 0 1 0 1 0 0 1 1 1

M₃=1 0 1 1 0 0 0 1 0 1 0 0 1 0 1 1

M₄=0 1 0 1 1 0 1 0 0 1 0 1 1 1 0 1

In accordance with the embodiment of the present invention, the output of the CRC generator 400 and the mask sequence M₁ are applied to the input of a first adder 420, the output of the CRC generator 400 and the mask sequence M₂ are applied to the input of a second adder 422, the output of the CRC generator 400 and the mask sequence M₃ are applied to the input of a third adder 424, and the output of the CRC generator 400 and the mask sequence M_{U} are applied to the input of a Uth adder 426. The adders 420 to 426 exclusive-OR operate the CRC output bits with the respective input mask sequences.

If U=4, the exclusive-OR operation results of the adders 420 to 426 are

First adder 420=0 0 1 1 0 0 0 0 0 0 0 1 1 1 0 0

Second adder 422=1 1 1 1 1 0 1 1 1 1 0 0 1 0 1 0

Third adder 424=0 0 0 1 0 0 1 0 0 0 1 0 0 1 1 0

Fourth adder 426=1 1 1 1 1 0 0 1 0 0 1 1 0 0 0 0

Channel encoders 430 to 436 encode the signals received from the adders 420 to 426 at a code rate of ½, for example, and each channel encoder outputs 32 code symbols. Symbol mappers 440 to 446 map the code symbols on a signal constellation of QPSK, 8PSK, 16QAM or 64QAM. The number of bits per symbol depends on a modulation scheme used. One symbol has 2 bits in QPSK, 3 bits in 8PSK, 4 bits in 16QAM, and 6 bits in 64QAM. If each of the symbol mappers 440 to 446 uses QPSK, it maps two sets of 16 code symbols, separately.

IFFTs 450 to 456 inverse-fast-Fourier-transform the mapped symbols. A selector 460 calculates the PAPR of the symbols received from the IFFTs 450 to 456 and selects symbols having the lowest PAPR. While the single selector 460 performs PAPR calculation and comparison and symbol selection, the operations can be implemented by use of two devices, that is, a PAPR calculator and a comparator & selector.

The selector 460 calculates the PAPRs of the received code symbols and selects code symbols having the lowest of U PAPRs. For example, if the code symbols corresponding to the mask sequence M₁ generated from the mask generator 410 has the lowest PAPR, the code symbols output from the IFFT 450 are selected for transmission to a receiver.

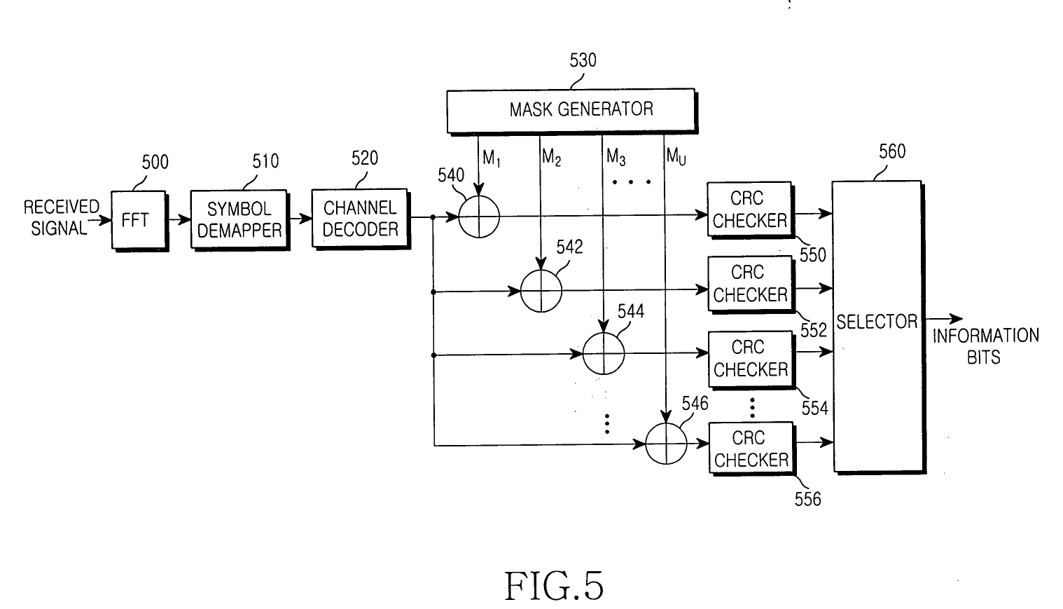

FIG. 5 is a block diagram of a receiver being the counterpart of the transmitter illustrated in FIG. 4.

Referring to FIG. 5, an FFT 500 fast-Fourier-transforms a signal received from the transmitter illustrated in FIG. 4. A symbol demapper 510, having the same signal constellation as that in the symbol mappers 440 to 446 of FIG. 4, converts the IFFT symbols to a binary signal according to the signal constellation. The symbol demapping depends on the symbol mapping. For example, if the modulation is QPSK, the demodulation is carried out based on QPSK. If the modulation is 8PSK, the demodulation is carried out based on 8PSK. After the symbol demapping, the received signal becomes a binary 32-bit signal.

A channel decoder 520 decodes the binary signal by a decoding method in correspondence with the coding method of the channel encoders 430 to 436. The decoded signal is copied to a plurality of (e.g. U) same signals and applied to adders 540 to 546. Meanwhile, a mask generator 530 generates a plurality of mask sequences and feeds them to adders 540 to 546. The mask generator 530 of the receiver has the same configuration as the mask generator 410 of the transmitter. The decoded signal and the mask sequence M₁ are applied to the input of a first adder 540, the decoded signal and the mask sequence M₂ are applied to the input of a second adder 542, the decoded signal and the mask sequence M₃ are applied to the input of a third adder 544, and the decoded signal and the mask sequence M_{U} are applied to the input of a Uth adder 546.

The adders 540 to 546 exclusive-OR operate the decoded signal with the respective input mask sequences, thereby eliminating the masks generated from the mask generator 410 of FIG. 4.

If U=4, the exclusive-OR operation results of the adders 540 to 546 are

First adder 540=1 0 1 0 0 0 1 1 0 1 1 0 1 1 0 1

Second adder 542=0 1 1 0 1 0 0 0 1 0 1 1 1 0 1 1

Third adder 544=1 0 0 0 0 0 0 1 0 1 0 1 0 1 1 1

Fourth adder 546=0 1 1 0 1 0 1 0 0 1 0 0 0 0 0 1

CRC checkers 550 to 556, configured in the same manner as the CRC generator 400 of FIG. 4, sequentially perform shifts and exclusive-OR operations on the bit streams received from the adders 540 to 546. The CRC checkers 550 to 556 operate in the same manner as the CRC generator 400 except for attachment of as many zeroes as the order of the CRC generator polynomial. The operation of the CRC checker 550 will be described with reference to FIG. 3.

The bits from the adder 540 are sequentially applied to the CRC checker 550, starting from the leftmost bit. It is assumed that a bit is moved from a shift register to the following shift register at time t1 and a bit is moved from the following shift register to the second following shift register at time t2 in the CRC checker 550. The shift registers 300 to 306 are all set to 0s, initially.

At t1, the EX-OR gate 310 exclusive-OR operates the first input bit 1 of the CRC checker 550 and the initial value 0 at the shift register 306 and the shift register 300 has the resulting value 1. The EX-OR gate 312 exclusive-OR operates the initial value 0s at the shift registers 300 and 306 and the shift register 302 has the resulting value 0. The EX-OR gate 314 exclusive-OR operates the initial value 0s at the shift registers 302 and 306 and the shift register 304 has the resulting value 0. The EX-OR gate 316 exclusive-OR operates the initial value 0s at the shift registers 304 and 306 and the shift register 306 has the resulting value 0. Therefore, 1, 0, 0, 0 are stored in the shift registers 300 to 306 at t1.

At t2, the EX-OR gate 310 exclusive-OR operates the second input bit 0 of the CRC checker 550 and the value 0 stored at the shift register 306 at t1 and the shift register 300 has the resulting value 0. The EX-OR gate 312 exclusive-OR operates the value 1 stored at the shift register 300 at t1 with the value 0 stored at the shift register 306 at t1 and the shift register 302 has the resulting value 0. The EX-OR gate 314 exclusive-OR operates the value 0 stored at the shift register 302 at t1 with the value 0 stored at the shift register 306 at t1 and the shift register 304 has the resulting value 0. The EX-OR gate 316 exclusive-OR operates the value 0 stored at the shift register 304 at t1 with the value 0 stored at the shift register 306 at t1 and the shift register 306 has the resulting value 0. Therefore, 0, 1, 0, 0 are stored in the shift registers 300 to 306 at t2.

At t3, the EX-OR gate 310 exclusive-OR operates the third input bit 1 of the CRC checker 550 and the value 0 stored at the shift register 306 at t2 and the shift register 300 has the resulting value 1. The EX-OR gate 312 exclusive-OR operates the value 0 stored at the shift register 300 at t2 with the value 0 stored at the shift register 306 at t2 and the shift register 302 has the resulting value 0. The EX-OR gate 314 exclusive-OR operates the value 1 stored at the shift register 302 at t2 with the value 0 stored at the shift register 306 at t2 and the shift register 304 has the resulting value 1. The EX-OR gate 316 exclusive-OR operates the value 0 stored at the shift register 304 at t2 with the value 0 stored at the shift register 306 at t2 and the shift register 306 has the resulting value 0. Therefore, 1, 0, 1, 0 are stored in the shift registers 300 to 306 at t3. Table 2 below lists values stored at the shift registers for the input bits of the CRC checker.

TABLE 2

| | CRC input | | | | |
|---|---|---|---|---|---|
| tim | bits | Register 300 | Register 302 | Register 304 | Register 306 |
| t1 | 1 | 1 | 0 | 0 | 0 |
| t2 | 0 | 0 | 1 | 0 | 0 |
| t3 | 1 | 1 | 0 | 1 | 0 |
| t4 | 0 | 0 | 1 | 0 | 1 |
| t5 | 0 | 1 | 1 | 0 | 1 |
| t6 | 0 | 1 | 0 | 0 | 1 |
| t7 | 1 | 0 | 0 | 1 | 1 |
| t8 | 1 | 0 | 1 | 1 | 0 |
| t9 | 0 | 0 | 0 | 1 | 1 |
| t10 | 1 | 0 | 1 | 1 | 0 |
| t11 | 1 | 1 | 0 | 1 | 1 |
| t12 | 0 | 1 | 0 | 1 | 0 |
| t13 | 1 | 1 | 1 | 0 | 1 |
| t14 | 1 | 0 | 0 | 0 | 1 |
| t15 | 0 | 1 | 1 | 1 | 1 |
| t16 | 1 | 0 | 0 | 0 | 0 |
| t17 | | 0 | 0 | 0 | 0 |
| t18 | | 0 | 0 | 0 | 0 |
| t19 | | 0 | 0 | 0 | 0 |

As noted from Table 2, the CRC checker 550 has 0,0,0,0 at the respective shift registers 300 to 306 after the final exclusive-OR operation. Therefore, the CRC checkers 552 to 556 have the final values listed in Table 3.

TABLE 3

| CRC checker | Register 300 | Register 302 | Register 304 | Register 306 |
|---|---|---|---|---|
| CRC checker | 0 | 1 | 0 | 0 |
| 552 | | | | |
| CRC checker | 0 | 0 | 1 | 1 |
| 554 | | | | |
| CRC checker | 1 | 0 | 0 | 1 |
| 556 | | | | |

The CRC checkers 550 to 556 output the final values at their shift registers and the bit streams from the adders 540 to 546. A selector 560 checks the shift register values of the CRC checkers 550 to 556. If the output of a CRC checker is 0, the selector 560 selects an adder output corresponding to a mask sequence resulting in the CRC check result, considering the mask sequence was selected in the transmitter.

That is, since the shift register values of the CRC checker 550 are all 0s, the selector 560 considers that they have no errors. On the other hand, since the shift register values of the CRC checkers 552 to 556 contain 1, the selector 560 considers that they have errors. Thus, the selector 560 determines that the bit stream received from the CRC checker 550 is the signal transmitted by the transmitter and selects 12 bits of the bit stream except for the last 4 CRC bits as the information bits. In the illustrated case, the receiver determines that the mask sequence M₁ generated from the mask generator 530 was selected by the transmitter.

Embodiment 2

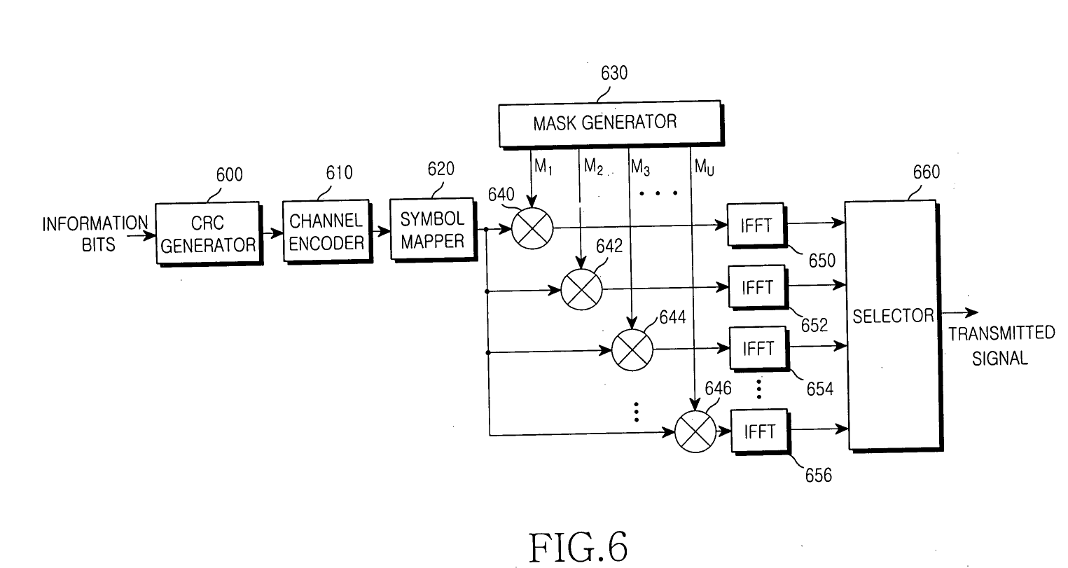

FIG. 6 is a block diagram of an OFDM transmitter based on the mask sequence-based SLM according to a second embodiment of the present invention. The transmitter uses a CRC generator like the transmitter of the first embodiment. However, while masking precedes channel encoding of information bits with CRC bits in the first embodiment, the masking follows channel encoding and symbol mapping of the information bits with CRC bits in the second embodiment. Therefore, the masking relies on exclusive-OR operation of the information bits with mask sequences on a bit basis in adders in the first embodiment, while the masking is carried out by multiplication of mapped symbols by the mask sequences on a bit basis in multipliers in the second embodiment.

Referring to FIG. 6, information bits are applied as a binary signal to the input of a CRC generator 600. The CRC generator 600 appends CRC bits generated in the manner as described with reference to FIG. 3 to the information bits. A channel encoder 610 encodes the binary bits received from the CRC generator 600. A symbol mapper 620 maps the code symbols on a signal constellation of QPSK, 8PSK, 16QAM or 64QAM. The number of bits per symbol depends on a modulation scheme used. One symbol has 2 bits in QPSK, 3 bits in 8PSK, 4 bits in 16QAM, and 6 bits in 64QAM. If each of the symbol mappers 440 to 446 uses QPSK, it maps two sets of 16 code symbols, separately. The mapped symbols are copied to a plurality of same signals, for example, U symbols in FIG. 6.

A mask generator 630 generates a plurality of independent mask sequences M₁ to M_{U}. The symbols from the symbol mapper 620 and the mask sequence M₁ are applied to the input of a first multiplier 640, the symbols and the mask sequence M₂ are applied to the input of a second multiplier 642, the symbols and the mask sequence M₃ are applied to the input of a third multiplier 644, and the symbols and the mask sequence M_{U} are applied to the input of a Uth multiplier 646.

The multipliers 640 to 646 multiply the received symbols by the respective mask sequences. Modulation symbols from the multiplier 640 are fed to a first IFFT 650, modulation symbols from the multiplier 642 are fed to a second IFFT 652, modulation symbols from the multiplier 644 are fed to a third IFFT 654, and modulation symbols from the multiplier 646 are fed to a Uth IFFT 656.

The IFFTs 650 to 656 inverse-fast-Fourier-transform the received symbols. A selector 660 calculates the PAPR of the symbols received from the IFFTs 650 to 656 and selects symbols having the lowest of the U PAPRs.

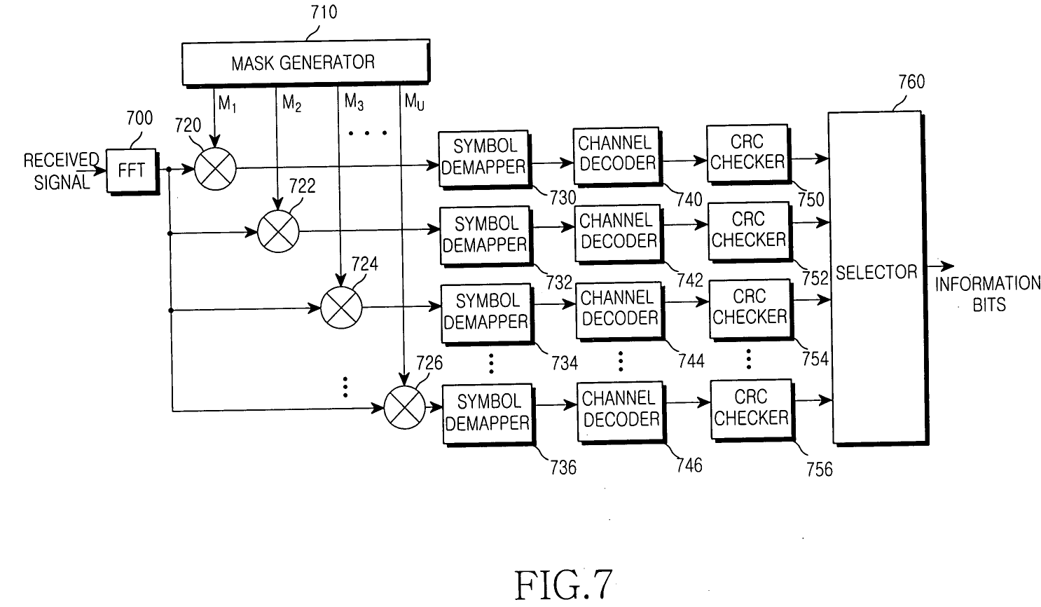

FIG. 7 is a block diagram of a receiver being the counterpart of the transmitter illustrated in FIG. 6. Referring to FIG. 7, an FFT 700 fast-Fourier-transforms a signal received from the transmitter illustrated in FIG. 6.

A mask generator 710 generates a plurality of independent mask sequences M₁ to M_{U}. The FFT signal and the mask sequence M₁ are applied to the input of a first multiplier 720, the FFT signal and the mask sequence M₂ are applied to the input of a second multiplier 722, the FFT signal and the mask sequence M₃ are applied to the input of a third multiplier 724, and the FFT signal and the mask sequence M_{U} are applied to the input of a Uth multiplier 726. The multipliers 720 to 726 multiply the FFT signal by the mask sequences M₁ to M_{U}, respectively.

Symbol demappers 730 to 736, having the same signal constellation as that in the symbol mapper 620 of FIG. 6, convert the symbols received from the multipliers 720 to 726 to binary signals according to the signal constellation. The symbol demapping depends on the symbol mapping. For example, if the modulation is QPSK, the demodulation is carried out based on QPSK. If the modulation is 8PSK, the demodulation is carried out based on 8PSK.

Channel decoders 740 to 746 decode the binary signals by a decoding method in correspondence with the coding method of the channel encoder 610.

CRC checkers 750 to 756, configured in the same manner as the CRC generator 600 of FIG. 6, sequentially perform shifts and exclusive-OR operations on the decoded signals. The CRC checkers 750 to 756 operate in the same manner as the CRC generator 600 except for attachment of as many zeroes as the order of the CRC generator polynomial.

The CRC checkers 750 to 756 operate in the same manner as the CRC checkers 450 to 456 illustrated in FIG. 5. The CRC checkers 750 to 756 output final values at their shift registers and the decoded binary signals from the decoders 740 to 746 to a selector 760. The selector 760 checks the shift register values of the CRC checkers 750 to 756. If the output of a CRC checker is all 0s, the selector 760 considers that it has no errors. If the output of a CRC checker contains 1, the selector 760 considers that it has errors. Thus, the selector 760 determines the output of a CRC checker with all 0s as a signal transmitted by the transmitter and selects 12 bits of a corresponding decoded signal except for the last 4 CRC bits as the information bits. The receiver also determines that a mask sequence corresponding to the selected decoded signal is the one selected by the transmitter.

Embodiment 3

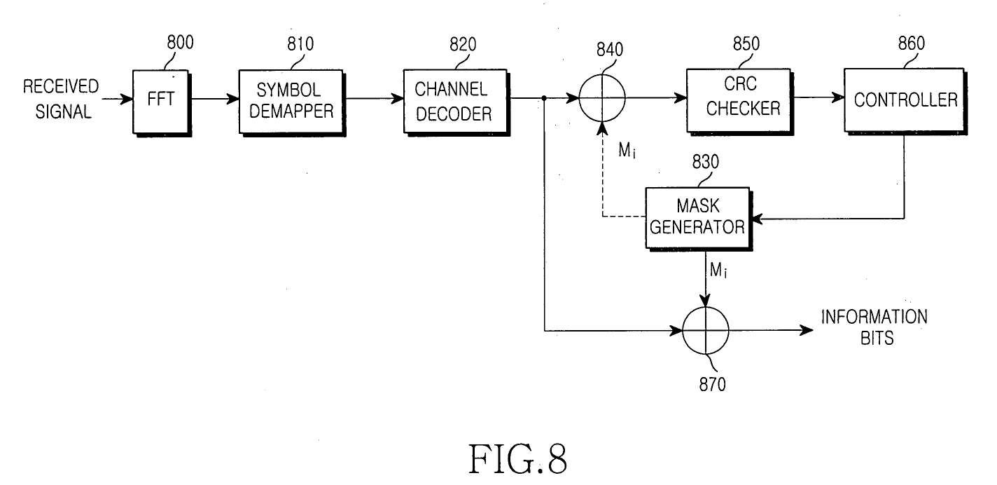

FIG. 8 is a block diagram of an OFDM receiver based on the mask sequence-based SLM according to a third embodiment of the present invention. In accordance with the third embodiment of the present invention, a transmitter is configured in the same manner as the transmitter illustrated in FIG. 4 where a CRC generator output is applied to a plurality of adders. The receiver according to the first embodiment operates a received signal with all mask sequences used in the transmitter to search for a selected mask sequence, whereas the receiver according to the third embodiment searches for a selected mask sequence using a single CRC checker.

Although a PAPR associated with the mask sequence M₁ is lowest in FIG. 4, it is assumed in FIG. 8 that the mask sequence M₂ is lowest. Therefore, the transmitter transmits a signal masked with the mask sequence M₂. If U=4, the mask sequences and (information bits+CRC bits) are defined as

Information bits+CRC=1 0 1 0 0 0 1 1 0 1 1 0 1 1 0 1

M₁=1 0 0 1 0 0 1 1 0 1 1 1 0 0 0 1

M₂=0 1 0 1 1 0 0 0 1 0 1 0 0 1 1 1

M₃=1 0 1 1 0 0 0 1 0 1 0 0 1 0 1 1

M₄=0 1 0 1 1 0 1 0 0 1 0 1 1 1 0 1

Referring to FIG. 8, an FFT 800 fast-Fourier-transforms a signal received from the transmitter illustrated in FIG. 4. A symbol demapper 810, having the same signal constellation as that in the symbol mappers 440 to 446 of FIG. 4, converts the IFFT symbols to a binary signal according to the signal constellation. The symbol demapping depends on the symbol mapping. For example, if the modulation is QPSK, the demodulation is carried out based on QPSK. If the modulation is 8PSK, the demodulation is carried out based on 8PSK. After the symbol demapping, the received signal becomes a binary 32-bit signal.

A channel decoder 820 decodes the binary signal by a decoding method in correspondence with the coding method of the channel encoders 430 to 436. The decoded signal, which is applied to adders 840 and 870, is

(Information bits+CRC)⊕M₂=1 1 1 1 1 0 1 1 1 1 0 0 1 0 1 0

The mask sequence M₂ generated from a mask generator 830 is detected as a mask sequence selected by the transmitter in a controller 860 in a manner described later. Hereinbelow, a description is made of an operation for detecting the mask sequence M₂ selected by the transmitter in a single CRC checker according to the third embodiment of the present invention.

One of a plurality of mask sequences generated from the mask generator 830 is applied to the input of the first adder 840. Let the input mask sequence be M₁. The first adder 840 exclusive-OR operates the decoded signal with the mask sequence M₁ and outputs

((information bits+CRC)⊕M2)⊕M1)=0 1 1 0 1 0 0 0 1 0 1 1 1 0 1 1

A CRC checker 850, configured in the same manner as the CRC generator 400 of FIG. 4, sequentially performs shifts and exclusive-OR operations on the bit stream received from the adder 840. The CRC checker 850 operates in the same manner as the CRC generator 400 except for attachment of as many zeroes as the order of the CRC generator polynomial. The CRC check result is 0100, which is fed to the controller 860. The controller 860 has the CRC result values of (M₁⊕M₂), (M₁⊕M₃), (M₁⊕M₄). If the mask sequence M₂ is applied to the first adder 840, the controller 860 has the CRC result values of (M₂⊕M₁), (M₂⊕M₃), (M₂⊕M₄). Table 4 below lists the CRC result values of (M₁⊕M₂), (M₁⊕M₃), (M₁⊕M₄).

TABLE 4

| | Exclusive-OR results | CRC check result |
|---|---|---|
| M₁ ^{⊕} M₂ | 1100101111010110 | 0100 |
| M₁ ^{⊕} M₃ | 0010001000111010 | 0011 |
| M₁ ^{⊕} M₄ | 1100100100101100 | 1001 |

The controller 860 compares the input binary CRC check result with a corresponding stored CRC check result. The input CRC check result and the stored CRC check result for M₁⊕M₂ are equal to 0100. Therefore, the controller 860 determines that a signal transmitted from the transmitter was masked with the mask sequence M₂ generated the mask generator 410. Hence, the controller 860 controls the mask generator 830 to generate the mask sequence M₂ and feed it to the second adder 870. The second adder 870 exclusive-OR operates the decoded signal with the mask sequence M₂, thereby eliminating the mask sequence M₂ from the transmitted signal. Consequently, 12 bits of the resulting 16-bit signal except for the last 4 CRC bits are selected as the information bits.

If the transmitted signal was masked with the mask sequence M₁ in the transmitter, the CRC checker 850 outputs 0000 as the CRC check result of the transmitted signal. In this case, the controller 860 finds out that the transmitter masked the transmitted signal with the mask sequence M₁. The controller 860 then controls the mask generator 830 to generate the mask sequence M₁ and feed it to the second adder 870.

In accordance with the present invention as described above, PAPR is effectively reduced without the need for transmitting additional information in an OFDM system, thereby resulting in effective use of limited channel resources, as compared to the conventional technology requiring transmission of the additional information. In addition, system complexity and implementation cost are reduced.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. In an OFDM (Orthogonal Frequency Division Multiplexing) system where the same information bit stream is masked with a plurality of different mask sequences and a masked information bit sequence having the lowest PAPR (Peak to Average Power Ratio) is selected for transmission among a plurality of masked information bit sequences, a method of generating the selected masked information bit sequence for transmission to a receiver, the method comprising the steps of:
generating an information sequence by adding CRC (Cyclic Redundancy Code) bits to an information bit stream, the CRC bits being used for error check;
generating a plurality of masked information sequences by masking the information sequence with a plurality of different mask sequences;
generating IFFT (Inverse Fast Fourier Transform) sequences by inverse-fast-Fourier-transforming the masked information sequences; and
selecting an IFFT sequence having the lowest PAPR among the IFFT sequences.

2. The method of claim 1, after the step of generating the masked information sequences, further comprising the steps of:
channel-encoding each of the masked information sequences; and
symbol-mapping each of the masked information sequences.

3. The method of claim 2, wherein the masked information sequences are generated by exclusive-OR operating the information sequence with the mask sequences.

4. The method of claim 1, after the step of generating the information sequence, further comprising the steps of:
channel-encoding the information sequence; and
symbol-mapping the encoded information sequence.

5. The method of claim 4, wherein the masked information sequences are generated by multiplying the mapped information sequence with the mask sequences on a bit basis.

6. The method of claim 1, wherein the IFFT sequence selecting step comprises the steps of:
calculating the PAPRs of the IFFT sequences; and
selecting the IFFT sequence having the lowest of the PAPRs.

7. In an OFDM (Orthogonal Frequency Division Multiplexing) system where the same information bit stream is masked with a plurality of different mask sequences and a masked information bit sequence having the lowest PAPR (Peak to Average Power Ratio) is selected for transmission among a plurality of masked information bit sequences, an apparatus for generating the selected masked information bit sequence for transmission to a receiver, the apparatus comprising:
a CRC (Cyclic Redundancy Code) generator for generating an information sequence by adding CRC bits to an information bit stream, the CRC bits being used for error check;
a plurality of maskers for generating a plurality of masked information sequences by masking the information sequence with a plurality of different mask sequences;
an IFFT (Inverse Fast Fourier Transformer) for generating IFFT sequences by inverse-fast-Fourier-transforming the masked information sequences; and
a selector for selecting an IFFT sequence having the lowest PAPR among the IFFT sequences.

8. The apparatus of claim 7, further comprising:
a channel encoder for encoding each of the masked information sequences; and
a symbol mapper for mapping each of the masked information sequences.

9. The apparatus of claim 8, wherein the masking operators are exclusive-OR gates for exclusive-OR operating the information sequence with the mask sequences.

10. The apparatus of claim 7, further comprising:
a channel encoder for encoding the information sequence; and
a symbol mapper for mapping the encoded information sequence.

11. The apparatus of claim 10, wherein the masking operators are multipliers for multiplying the mapped information sequence with the mask sequences on a bit basis.

12. The apparatus of claim 7, further comprising a mask generator for generating the mask sequences.

13. The apparatus of claim 7, wherein the selector comprises:
a PAPR calculator for calculating the PAPRs of the IFFT sequences; and
a comparison and selection unit for comparing the PAPRs and selecting the IFFT sequence having the lowest of the PAPRs.

14. In an OFDM (Orthogonal Frequency Division Multiplexing) system where the same information bit stream is masked with a plurality of different mask sequences and a masked information bit sequence having the lowest PAPR (Peak to Average Power Ratio) is selected for transmission among a plurality of masked information bit sequences, a method of determining the selected masked information bit sequence received from a transmitter, the method comprising the steps of:
generating an FFT (Fast Fourier Transform) sequence by fast-Fourier-transforming a received masked information sequence;
masking the FFT sequence with a plurality of different mask sequences used by a transmitter;
checking errors using CRC (Cyclic Redundancy Code) bits of each of the masked information sequences; and
detecting a mask sequence selected by the transmitter according to the CRC check results.

15. The method of claim 14, after the FFT sequence generating step, further comprising the steps of:
symbol-demapping the FFT sequence; and
channel-decoding the demapped information sequence.

16. The method of claim 15, wherein the FFT sequence is masked by exclusive-OR operating the FFT sequence with the mask sequences.

17. The method of claim 14, after the masking step, further comprising the steps of:
symbol-demapping the masked information sequences; and
channel-decoding the demapped information sequences.

18. The method of claim 17, wherein the FFT sequence is masked by multiplying the FFT sequence by the mask sequences.

19. The method of claim 14, wherein a mask sequence determined to be error-free at the CRC check is selected in the mask sequence selecting step.

20. In an OFDM (Orthogonal Frequency Division Multiplexing) system where the same information bit stream is masked with a plurality of different mask sequences and a masked information bit sequence having the lowest PAPR (Peak to Average Power Ratio) is selected for transmission among a plurality of masked information bit sequences, a method of determining the selected masked information bit sequence received from a transmitter, the method comprising the steps of:
generating an FFT (Fast Fourier Transform) sequence by fast-Fourier-transforming a received masked information sequence;
symbol-demapping the FFT sequence;
channel-decoding the demapped information sequence;
masking the decoded information sequence with a predetermined mask sequence and checking errors by CRC (Cyclic Redundancy Code) bits of the masked information sequence; and
detecting a mask sequence selected by a transmitter according to the CRC check result and generating information bits by masking the decoded information sequence with the detected mask sequence.

21. The method of claim 20, wherein the mask sequence is detected by comparing the CRC check result with the CRC check results of all stored mask sequences.

22. In an OFDM (Orthogonal Frequency Division Multiplexing) system where the same information bit stream is masked with a plurality of different mask sequences and a masked information bit sequence having the lowest PAPR (Peak to Average Power Ratio) is selected for transmission among a plurality of masked information bit sequences, an apparatus for determining the selected masked information bit sequence received from a transmitter, the apparatus comprising:
a FFT (Fast Fourier Transformer) for generating an FFT sequence by fast-Fourier-transforming a received masked information sequence;
a masker for masking the FFT sequence with a plurality of different mask sequences used by a transmitter;
a CRC (Cyclic Redundancy Code) checker for checking errors by CRC bits of each of the masked information sequences; and
a selector for detecting a mask sequence selected by the transmitter according to the CRC check results and selecting a masked information sequence corresponding to the detected mask sequence.

23. The apparatus of claim 22, further comprising:
a symbol demapper for demapping the FFT sequence; and
a channel decoder for decoding the demapped information sequence.

24. The apparatus of claim 22, further comprising an exclusive-OR gate for exclusive-OR operating the FFT sequence with the mask sequences.

25. The apparatus of claim 22, further comprising:
a symbol demapper for demapping the masked information sequences; and
a channel decoder for decoding the demapped information sequences.

26. The apparatus of claim 25, further comprising a multiplier for multiplying the FFT sequence by the mask sequences.

27. In an OFDM (Orthogonal Frequency Division Multiplexing) system where the same information bit stream is masked with a plurality of different mask sequences and a masked information bit sequence having the lowest PAPR (Peak to Average Power Ratio) is selected for transmission among a plurality of masked information bit sequences, an apparatus for determining the selected masked information bit sequence received from a transmitter, the apparatus comprising:
an FFT (Fast Fourier Transformer) for generating an FFT sequence by fast-Fourier-transforming a received masked information sequence;
a symbol demapper for demapping the FFT sequence;
a channel decoder for decoding the demapped information sequence;
a masker for masking the decoded information sequence with a predetermined mask sequence;
a CRC (Cyclic Redundancy Code) checker for checking errors by CRC bits of the masked information sequence; and
a controller for detecting a mask sequence selected by a transmitter according to the CRC check result and generating information bits by masking the decoded information sequence with the detected mask sequence.

28. The apparatus of claim 27, wherein the masker comprises:
a mask generator for generating the predetermined mask sequence; and
an adder for exclusive-OR operating the mask sequence with the decoded information sequence.

29. The apparatus of claim 27, wherein the controller has the CRC check results of all mask sequences.
